(19) United States
(12) Patent Application Publication
(10) Pub. No.: US 2012/0234253 A1
(43) Pub. Date: Sep. 20, 2012

(54) Portable pet toilet

(76) Inventors: Michele Malm, Los Gatos, CA (US); Peter J. Palmer, Los Gatos, CA (US); Theresa Marler, Los Gatos, CA (US)

(21) Appl. No.: 13/065,073

(22) Filed: Mar. 14, 2011

(51) Int. Cl. A01K 29/00

(52) U.S. Cl. 119/169; 119/171

(57) ABSTRACT

A portable pet toilet comprising three layers; a surface layer designed such that a pet is encouraged to urinate upon it, a bottom layer (shield layer) designed to prevent urine from contaminating any floor material upon which it rests, and an intermediate layer designed to absorb and retain the amount of urine that can be expected to be excreted by the pet. The bottom layer is afforded with a means for securing the position of the other two layers while allowing all three layers to be formed into a compact roll to facilitate portability.

### BACKGROUND

1. Field of the Invention

Aspects of the present invention relate generally to a toilet designed for the use of pets with the intent of preventing the pet's urine from contaminating the environment surrounding the toilet. A key aspect of the patent is the portability of the device when not in use.

2. Description of Related Art

It is common for people living in housing with no easy access to a garden to allow pets to roam freely within the confines of the abode. If this is allowed for an extended period of time, the pet will eventually need to urinate. Allowing a pet to urinate unconditionally within an inhabited area is clearly contrary to good health practice and therefore it is highly desirable to confine the urination to a small area where the urine can be collected and disposed of hygienically.

Some pets (such as cats) can often be trained to urinate in a tray, which is often filled with a substance (generally known as cat litter) designed to absorb the urine and to reduce or camouflage the odor generated by the urine. Other pets (notably dogs) are difficult or impossible to train in this manner, and therefore an alternative solution is highly desirable.

It has been found that such pets can often be enticed to urinate in a particular area if it mimics the environment where they would normally urinate naturally. The usual method for accomplishing this is by means of an area of artificial turf, similar to the type used on sports fields. Additional incentive is often provided by impregnating the turf with chemicals which the pet's sense of smell associates with a region frequently used for urination by other pets.

Artificial turf is very porous, and offers little resistance to the passing of urine; therefore some means of containing the urine is still necessary. Placing the turf in a tray filled with “cat litter” is not a practical solution to containment since the relatively high sides of the tray detract from the aim of providing an area which looks natural to the pet. To overcome this problem, the cat litter is often replaced with a relatively thin sheet of absorbent material. When the material becomes saturated with urine, the absorbent sheet can be discarded and replaced or else washed and re-used. Examples of pet toilets of this type can be found in U.S. Pat. Nos. 5,819,688, 7,128,023 and 7,568,448.

The present invention enhances the toilet design by making the bottom layer from a flexible material in such a manner that it can be flattened into a uniform plane. Therefore the bottom layer and the other two layers (which are already flexible and planar) can be formed into a compact roll so that the toilet can be easily transported or stored.

### SUMMARY OF THE INVENTION

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a vertically sectioned view of a typical existing pet toilet showing the arrangement of the surface layer, intermediate (absorbent) layer and the bottom (shield) layer.

FIG. 2 is a vertically sectioned view through a typical existing pet toilet illustrating the usual arrangement where the shield layer is formed into a tray containing the other two layers.

FIG. 3 is a perspective view illustrating the shield layer of the invention configured in its natural (flat) shape.

FIG. 4 is a perspective view illustrating the pet toilet of the invention with the shield layer of the invention configured in its normal operating shape.

FIG. 5 is a vertically sectioned view through the invention illustrating how the shield layer is formed into a tray containing the other two layers.

FIG. 6 is a side view illustrating the pet toilet of the invention after being formed into a roll for transportation.

### DETAILED DESCRIPTION OF THE INVENTION

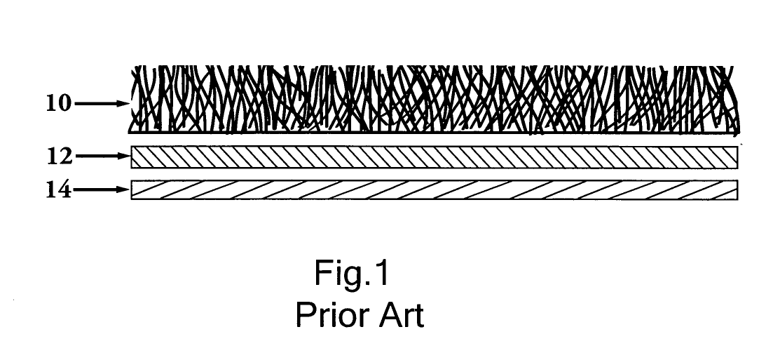

By way of illustration, FIG. 1 shows the cross section through the center of a typical existing pet toilet. The structure consists of an upper layer 10 fabricated as to mimic a naturally occurring surface (such as turf) familiar to the pet. Below this is an absorbent intermediate layer 12 of sufficient volume to contain the required amount of pet urine. Below this is an impermeable layer (shield layer) 14 to prevent urine at the bottom of the absorbent layer from contaminating the area upon which the toilet is placed.

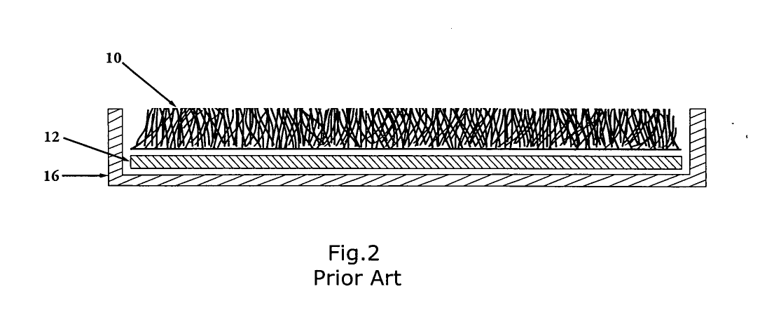

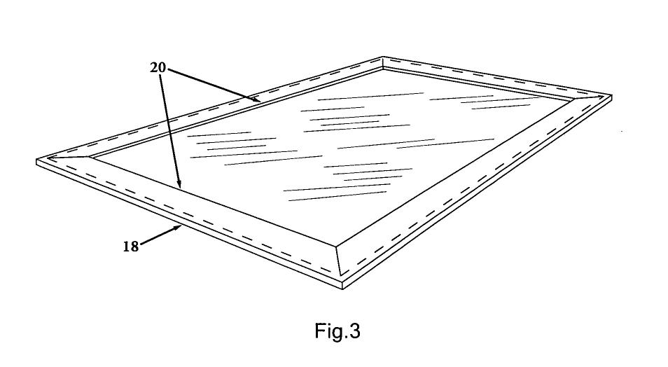

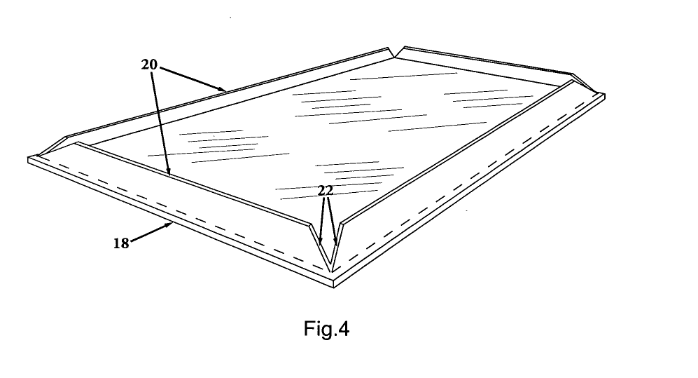

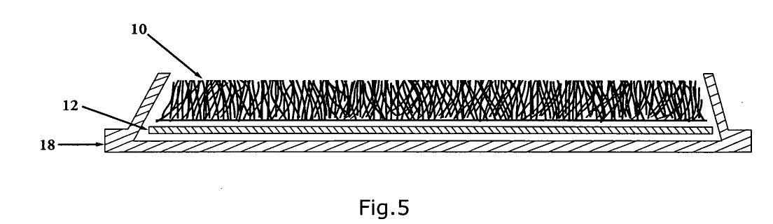

FIG. 2 shows a cross section of a complete toilet, where the shield layer (14 in FIG. 1) has been formed into a tray 16, thus effectively restricting the movement of the upper layer 10 and absorbent layer 12, and ensuring that both layers stay within the borders of the shield layer 16. It should be noted that FIG. 2 and the later figures FIG. 3, FIG. 4 and FIG. 5 are not to scale with respect to the relative horizontal and vertical dimensions; typical horizontal dimensions would likely be in the range of 50 to 100 centimeters and the vertical dimension of the shield layer would likely be in the range of 2.5 to 5 centimeters.

The essence of the invention is depicted in the perspective view of FIG. 3. The shield layer 18 is no longer permanently formed into a tray, but is fabricated from an impermeable material having edges 20 that are normally held flat by the intrinsic resilience of the material. FIG. 4 shows how these edges can be folded upward to provide effective containment of the upper and absorbent layers, while still ensuring that both layers stay within the borders of the shield layer. The resulting cross section is shown in FIG. 5 showing how the raised edges 20 fulfill the same function as the tray 16 in FIG. 2. Referring to FIG. 4, the corners 22 of the shield layer 18 are not necessarily completely sealed as in the case of a conventional tray formation, but this is generally of no importance since the absorbent layer usually has sufficient lateral dimensions to ensure that no urine permeates to its corners. Because the material used to fabricate the bottom layer has a measure of intrinsic resilience, the raised edges will tend to return to their unraised (flat) position. This creates a clamping action which grips the upper two layers around the edges, rendering the entire assembly resistant to dislocation.

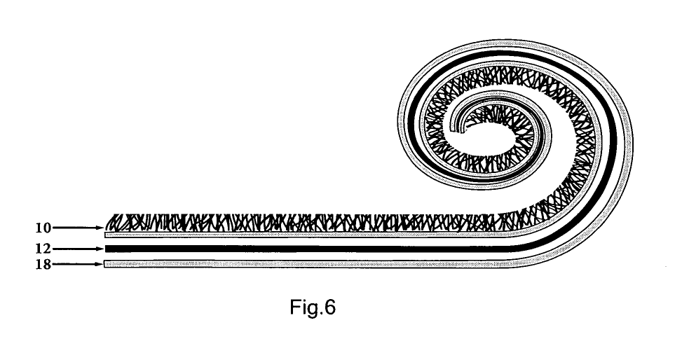

Because the shield layer lies flat when not assembled into a toilet, many such layers can be stacked and packed into a compact space, which makes them economical to distribute. Of more importance to the consumer is the ability to form all three layers into a roll, which makes the toilet easy to store and transport when not being used for its intended purpose. FIG. 6 is a side view of the toilet illustrating the position of the upper layer 10, absorbent layer 12, and the shield layer 18 after being formed into a such a roll.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An apparatus for the collection and containment of pet urine, comprising:
A porous and permeable upper layer, fabricated in a fashion which mimics a naturally occurring surface such as turf, an absorbent intermediate layer, and an impermeable bottom layer which lies flat when not attached to the other two layers.

2. The apparatus of claim 1, where the upper two layers are of the same planar dimensions and the bottom layer is of slightly larger planar dimensions.

3. The apparatus of claim 2, where the edges of the bottom layer can be folded upward to act as a container for the upper two layers.

4. The apparatus of claim 3, where the intrinsic resilience of the material from which the bottom layer is fabricated creates a tendency for the edges to return to the flat position, thus creating a clamping action to grip the upper two layers around the edges.

5. The apparatus of claim 1, where the bottom layer is fabricated from a single sheet of plastic material.

6. The apparatus of claim 1, where the bottom layer can be folded into a roll for transportation or storage purposes.

7. The apparatus of claim 1, where the bottom layer and the two upper layers can be stacked and folded into a single roll for transportation or storage purposes.
